(19) United States
(12) Patent Application Publication
(10) Pub. No.: US 2026/0162540 A1
(43) Pub. Date: Jun. 11, 2026

(54) GENERATING ATTRIBUTE LABELS FOR AVIATION NOTICES

(71) Applicant: Honeywell International Inc., Charlotte, NC (US)

(72) Inventors: Minal Dani, Bangalore (IN); Raghu Shamasundar, Bangalore (IN); Mythili Kamath, Bangalore (IN); Sreedhara Mallavarapu, Bangalore (IN); Munendra Desarkar, Hyderabad (IN)

(21) Appl. No.: 19/080,799

(22) Filed: Mar. 15, 2025

(30) Foreign Application Priority Data
Dec. 6, 2024 (IN) 202411096639

(51) Int. Cl. G08G 5/20; G06F 40/284; G06N 3/0442; G06N 20/20

(52) U.S. Cl. CPC G08G 5/20; G06F 40/284; G06N 3/0442; G06N 20/20

(57) ABSTRACT

Approaches for generating attribute labels for aviation notices are described. According to one example, a system employs a machine learning pipeline to analyse and label aviation notices with pre-defined formats. The process involves tokenizing the aviation notices, generating vector embeddings, and using models such as Bidirectional Long Short-Term Memory (BiLSTM) and Conditional Random Field (CRF) to identify attributes and assign labels. The system incorporates pre-defined rules, real-time updates, and anomaly detection through comparison with historical notices. The labelled aviation notices are transmitted to different devices, such as avionic systems or user terminals.

### BACKGROUND

Aviation notices, such as Notices to Airmen (NOTAMs), are critical communications in aviation industry that provide essential, time-sensitive information to pilots, air traffic controllers, and other aviation personnel. NOTAMs play a vital role in ensuring flight safety, as they contain crucial updates that may impact flight planning, navigation, and operations. The information conveyed in NOTAMs may range from runway closures and airspace restrictions to changes in navigational aids or the presence of obstacles.

### SUMMARY OF INVENTION

This summary is provided to introduce concepts related to generating attribute labels for aviation notices. This summary is not intended to identify essential features of the claimed subject matter nor is it intended for use in determining or limiting the scope of the claimed subject matter.

In an aspect of the present subject matter, a system for generating attribute labels for aviation notices is disclosed. The system includes a processor and a machine-readable storage medium comprising instructions executable by the processor. The instructions when executed cause the processor to obtain a plurality of tokens associated with an aviation notice. In an example, the aviation notice has a pre-defined format. Further, one or more segments may be identified using a machine learning model, in the plurality of tokens. The machine learning model may be pre-trained on a set of attributes pertaining to flight related parameters pertaining to corresponding aviation notices. In an example, a segment is indicative of an attribute associated with the aviation notice. In addition, a label may be associated with the attribute defined within each of the one or more segments. The label may be associated with the attribute based on pre-defined rules. Based on the label, a labelled aviation notice may be obtained. Further, the labelled aviation notice may be transmitted to an avionic system.

In an aspect of the present subject matter, a method for generating attribute labels for aviation notices is disclosed. The method includes receiving an aviation notice from a first terminal. The aviation notice may have a pre-defined format. The method further includes generating a plurality of vector embeddings corresponding to the aviation notice. Each of the plurality of vector embeddings may be indicative of a word in the aviation notice. In addition, based on the plurality of vector embeddings, the method includes determining segment boundaries in the aviation notice. A segment boundary may separate a first attribute from a second attribute in the aviation notice. Thereafter, the method includes associating a label with each attribute defined in the aviation notice and determined by the segment boundary. In an example, the label may be associated using a machine learning model. In an example, the machine learning model may be pre-trained on a set of segments pertaining to attributes associated with corresponding aviation notices. The labelled aviation notice may be displayed on a second terminal.

In yet another aspect of the present subject matter, a non-transitory computer readable medium for generating attribute labels for aviation notices is disclosed. The non-transitory computer readable medium has instructions stored thereon. The instructions, when executed by a processor, cause the processor to perform operations. In the operations, filtering of a plurality of aviation notices is performed based on pre-defined rules to obtain a valid set of aviation notices. The valid set of aviation notices may have a pre-defined format. Further, the operations cause to generate a plurality of vector embeddings corresponding to each valid aviation notice from the set of valid aviation notices. Each of the plurality of vector embeddings is indicative of a word in the valid aviation notice. The plurality of vector embeddings is input in a machine learning model to detect one or more attributes associated with the aviation notices. In addition, the operations cause to assign one or more labels to each attribute to generate a labelled aviation notice. For example, the one or more labels may be assigned by a sequence labelling model. The labelled aviation notice may be notified to an avionic system.

### BRIEF DESCRIPTION OF FIGURES

Systems and/or methods are now described, in accordance with examples of the present subject matter and with reference to the accompanying figures, in which:

FIG. 1 illustrates a system for generating attribute labels for aviation notices, according to an example;

FIG. 2 illustrates a communication environment comprising an annotation system for generating attribute labels for aviation notices, according to an example;

FIG. 3 illustrates a schematic block diagram of a training system for training an annotation system for generating attribute labels for aviation notices, according to an example;

FIG. 4 illustrates a schematic block diagram of a system for generating attribute labels for aviation notices, according to another example;

FIG. 5 illustrates an exemplary schematic block diagram depicting generation of attribute labels for aviation notices, according to an example;

FIG. 6 illustrates a method for generating attribute labels for aviation notices, according to an example;

FIG. 7 illustrates a method for training an annotation system for generating attribute labels, according to another example;

FIG. 8 illustrates a method for generating attribute labels for aviation notices, according to another example; and

FIG. 9 illustrates a computing environment implementing a non-transitory computer-readable medium for generating attribute labels for aviation notices, according to an example.

### DETAILED DESCRIPTION

Aviation notices, particularly NOTAMs, are essential for flight crews during pre-flight preparations and for air traffic controllers. These notices employ a cryptic and abbreviated language, which presents significant challenges in accurately interpreting various attributes associated with each NOTAM. These attributes may include effective dates, geographical areas, altitudes, and specific operational restrictions.

Due to inconsistent structure and presentation of the NOTAM attributes existing language models may be unable to automatically parse and extract attributes from the NOTAMs. Moreover, the time-sensitive nature of these attributes may amplify the importance of rapid and accurate interpretation of the NOTAMs, as misunderstanding any single attribute may have serious safety implications. The high volume of daily NOTAM dissemination makes thorough manual processing impractical and prone to human error, necessitating more efficient and accurate processing methods.

In addition, the variation in NOTAM formats across issuing authorities leads to inconsistent presentation of attributes, hindering standardized automated processing. Additionally, instead of explicitly stating, the attributes may be implicitly stated. This may require domain-specific knowledge to infer the attributes, thereby further challenging automated systems. Although machine learning models may be used, the lack of annotated training data, due to the specialized nature of NOTAMs, impedes the development of effective machine learning models. While rule-based systems offer some utility, they may often lack the flexibility to adapt to the dynamic nature of NOTAM information. Furthermore, integrating NOTAM information with other aviation data sources and systems poses additional challenges, potentially creating gaps in situational awareness and decision-making processes within the aviation industry.

To this end, approaches for segmenting and labelling attributes in the aviation notices are described. The present subject matter facilitates generating a labelled aviation notice thereby facilitating seamless transmission of processed information to avionic systems, enhancing real-time data utilization and decision-making.

In one example, a plurality of aviation notices may be obtained and filtered to remove duplicate and outdated notices. Thereafter, a valid set of aviation notices may be extracted. A valid aviation notice, such as a Notice to Airmen (NOTAM), may have a pre-defined format. Thereafter, a plurality of tokens associated with an aviation notice may be obtained. Each of the plurality of tokens may separate text from the aviation notice into individual words, numbers, or symbols, allowing for more granular analysis and processing of the aviation notice.

Further, based on the plurality of tokens one or more segments may be identified. A segment may be indicative of an attribute associated with the aviation notice. In an example, the one or more segments may be identified by a machine learning model, such as a Bidirectional long short-term memory (BiLSTM) model. The machine learning model may be pre-trained on a set of attributes associated with different aviation notices.

In continuation, at least one label may be associated with the one or more identified segments using a machine learning model, to obtain labelled aviation notice. The label may correspond to the attribute defined within each of the segments. The association of the at least one label may be based on certain pre-defined rules. For example, in a NOTAM stating “RWY 09/27 CLSD”, the present subject matter may associate “RWY 09/27” with a label as “LOCATION” and “CLSD” as “STATUS”. Thereafter, the labelled aviation notice may be transmitted to an avionic system for ease of comprehension by pilots. For example, the labelled aviation notice may translate into more easily understood phrases or symbols.

The present subject matter provides several advantages in the processing and utilization of aviation notices. By implementing a sophisticated pipeline that includes filtering, tokenization, segmentation, and labelling, the present subject matter facilitates improving the accuracy and efficiency of aviation notice interpretation. This automated approach reduces the risk of human error in parsing complex notices and ensures critical information is not overlooked. The use of machine learning models for segment identification and CRF for labelling, allows for adaptive and context-aware processing, capable of handling diverse notice formats and content. By transforming unstructured text into structured, labelled data, the present subject matter facilitates seamless integration with avionic systems, enabling real-time updates and enhancing situational awareness for pilots and air traffic controllers. This structured format also allows for easier querying, analysis, and integration with other aviation data systems, potentially improving overall flight safety and operational efficiency. Furthermore, processing large volumes of notices quickly and accurately may lead to significant time and resource savings for aviation authorities and operators, while ensuring that all relevant information is promptly disseminated to the appropriate stakeholders.

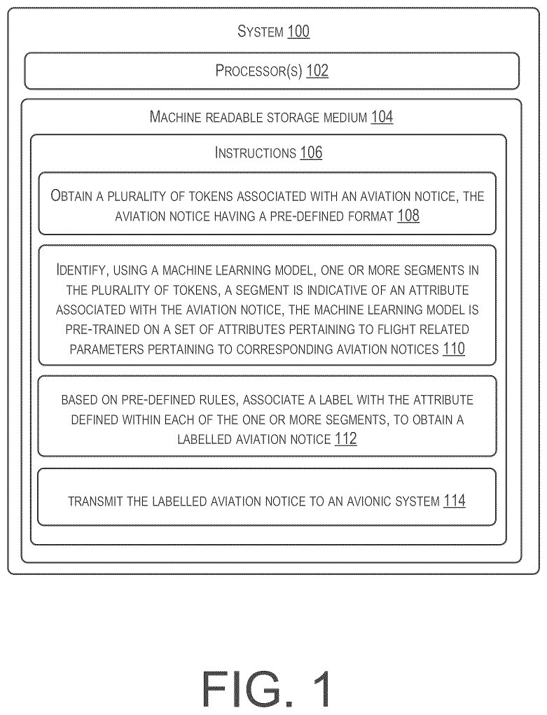

The present subject matter is further described with reference to FIG. 1 to FIG. 9. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a system 100 for generating attribute labels for avionic notices, according to an example. As used herein, the term “aviation notice” may refer to an official communication or alert issued to inform pilots, air traffic controllers, and other aviation personnel about conditions, restrictions, or changes that may affect flight operations or safety. An aviation notice may contain information related to weather, airspace, airport facilities, navigation aids, or other operational factors relevant to aviation. Aviation notices may be issued by various authorities such as civil aviation organizations, air traffic control centers, meteorological services, or airport operators. These notices may be distributed through standardized formats and systems to ensure timely and widespread dissemination of critical information to the aviation community. Examples of the aviation notice may include, but are not limited to, notice to airmen (NOTAM), significant meteorological information (SIGMET), temporary flight restriction (TFR), and so on.

The attributes associated with the aviation notices may refer to specific characteristics, categories, or data fields that describe and classify various aspects of an aviation notice. These attributes may be used to categorize, filter, and prioritize the aviation notices within information management systems, facilitating efficient dissemination and interpretation of critical aviation information. Examples of the attributes may include, but are not limited to, notice type, affected area, validity period, severity level, and so on.

The system 100 may be a device, such as an electronic device, that may be operated by a user for generating the attribute labels. Examples of the electronic device may include, but are not limited to, a laptop, a desktop, a tablet computer, and a smartphone. The system 100 may be implemented in any computing system, such as a storage array, server, desktop or a laptop computing device, a distributed computing system, or the like. Although not depicted, the system 100 may include other components, such as interfaces to communicate over the network or with external storage or computing devices, display, input/output interfaces, operating systems, applications, data, and other software or hardware components (all of which have not been depicted).

In one example, the system 100 may be a standalone server or may be a remote server on a cloud computing platform. In a preferred example, the system 100 may be a cloud-based system. The system 100 is capable of delivering applications (such as cloud applications) for segmenting attributes and generating labels for each attribute of the aviation notice.

The system 100 may include a processor 102 and a machine-readable storage medium 104 which is coupled to, and accessible by, the processor 102. The processor 102 may be implemented as a dedicated processor, a shared processor, or a plurality of individual processors, some of which may be shared. The processor(s) 102 may include microprocessors, microcomputers, microcontrollers, digital signal processors, central processing units, state machines, logic circuitries, and/or any other devices that manipulate signals and data based on computer-readable instructions. Further, functions of the various elements shown in the figures, including any functional blocks labelled as “processor(s)”, may be provided through the use of dedicated hardware as well as hardware capable of executing computer-readable instructions.

The machine-readable storage medium 104 may be communicatively connected to the processor 102. Among other capabilities, the processor 102 may fetch and execute computer-readable instructions, including instructions 106, stored in the machine-readable storage medium 104. The machine-readable storage medium 104 may include non-transitory computer-readable medium including, for example, volatile memory such as RAM (Random Access Memory), or non-volatile memory such as EPROM (Erasable Programmable Read Only Memory), flash memory, and the like. The instructions 106 may be executed to classify the hardware components of the computing device.

In an example, the processor 102 may fetch and execute the instructions 106. In one example, as a result of the execution of the instructions 108, the system 100 may obtain a plurality of tokens associated with an aviation notice. The aviation notice may have a pre-defined format. In an example, the aviation notice, such as a NOTAM, may include abbreviated and cryptic information about flight operations. Each of the plurality of tokens may indicate a word in the text of the aviation notice. In an example, the plurality of tokens may be generated by the system 100 or may be generated by an external service or system. For example, the external service or system may process the aviation notice and generate tokens. Thereafter, the system 100 may obtain these pre-generated tokens, such as by an application programming interface (API) call to an external tokenization service, retrieving tokens from a shared database or data store, and so on.

Upon obtaining the plurality of tokens, the instructions 110 may be executed to identify one or more segments in the plurality of tokens. In an example, a segment is indicative of an attribute associated with the aviation notice. Further, the one or more segments may be identified using a machine learning model which may be pre-trained on a set of attributes pertaining to flight related parameters pertaining to corresponding aviation notices. The machine learning model may be a Recurring Neural Network (RNN), such as a bidirectional Long Short Term Memory (BILSTM) model. The BILSTM model may be particularly effective in capturing contextual information from both past and future states, allowing the system 100 to better understand the relationships between tokens in the aviation notice.

Once the segments are identified, the instructions 112 may be executed to associate a label with the attribute defined within each of the one or more segments. In an example, the label may be associated to obtain a labelled aviation notice. The label may serve to categorize and organize the information contained in the aviation notice, thereby making the aviation notice easily interpretable and processable by avionic systems. In an example, labels may be pre-defined based on common attributes found in the aviation notices and may correspond to specific fields or data elements relevant to aviation operations and safety.

To this end, the instructions 114 may be executed such that the labelled aviation notice may be transmitted to an avionic system. The transmission of the labelled aviation notice may occur through various communication channels, such as satellite networks, ground-based data links, or wireless protocols specific to aviation. The avionic system receiving the labelled notice may be onboard an aircraft, at an air traffic control center, or part of a ground-based flight management system. By transmitting the labelled aviation notice, the system 100 may enable the efficient dissemination of critical information to relevant stakeholders in a format that can be readily interpreted and acted upon. The labels associated with the aviation notice may facilitate automated processing and integration of the information into the avionic system's workflows, potentially triggering alerts, updates to flight plans, or other appropriate responses based on the content and classification of the aviation notice.

The above functionalities performed as a result of the execution of the instructions 106, may be performed by different programmable entities. Such programmable entities may be implemented through any computing systems, which may be implemented either on a single computing device, or multiple computing devices. As will be explained, various examples of the present subject matter are described in the context of a computing system which obtains interactable components as a result of user selection and generate presentation formats. These and other examples are further described with respect to the remaining figures.

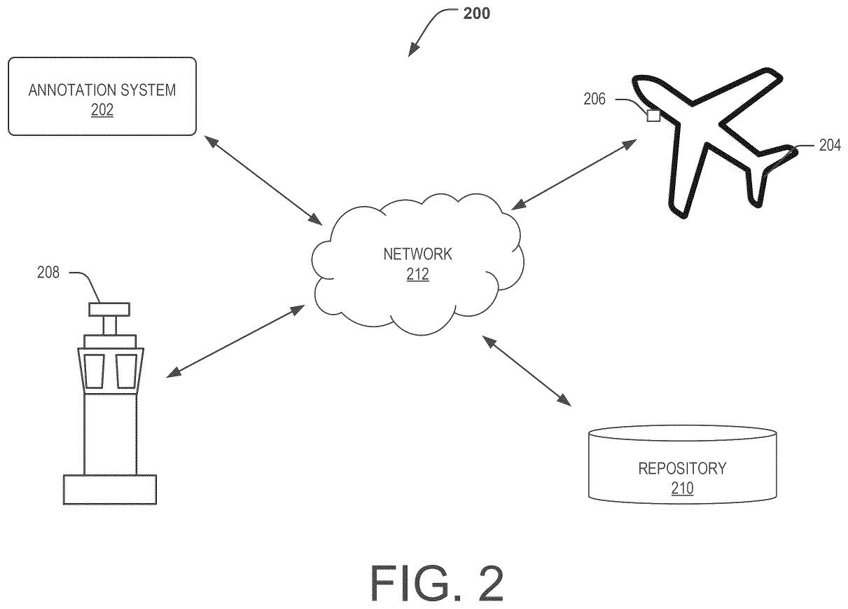

FIG. 2 illustrates a communication environment 200 comprising an annotation system 202 for generating attribute labels and annotating the aviation notices with such generated attribute labels, for avionic systems onboard an aircraft 204, according to an example. The communication environment 200 may include, without limitation, the annotation system 202 that may communicate with communication device(s) 206 onboard the aircraft 204, air traffic control (ATC) 208 or other ground systems, and a repository 210, via a network 212. In an example, certain embodiments of the communication environment 200 may include additional or alternative elements and components, as desired for the particular application.

The annotation system 202 may be similar to the system 100 and may operate to segment attributes, generate attribute labels, and render the labelled aviation notices onboard the aircraft 204 during flight. The annotation system 202 may be implemented by any computing device that includes at least one processor, a memory, a user interface, and a communication hardware. annotation system 202 In the present example, the annotation system 202 may be configured to segment attributes and generate labels for each attribute of the aviation notice. In other example, the annotation system 202 may be implemented using a computer system onboard and/or integrated into the aircraft 204, which is configured to segment attributes and generate labels for each attribute of the aviation notice.

The aircraft 204 may be any aviation vehicle by which messages or other communications transmitted by the air traffic control 208 are received and used by the flight crew for decision making purposes during flight. The aircraft 204 may be an airplane, helicopter, spacecraft, hovercraft, or the like. The communication devices 206 may include, but are limited to, a cockpit receiver, a Controller Pilot Datalink Communication (CPDLC) device, an Automatic Terminal Information Service (ATIS) receiver, a Notice to Airmen (NOTAM) receiver, or an aircraft radio. Data obtained from the one or more communication devices 206 may include, without limitation: Notice to Airmen (NOTAM) data, taxi clearance data, a current flight path for the aircraft, and timing data associated with the current flight path; and/or any other type of data received onboard the aircraft 204 which may be obtained by the annotation system 202 via the network 212.

The repository 210 may include any number of application servers, and each server may be implemented using any suitable processor based system capable of executing one or more instructions. In some embodiments, the repository 210 may include one or more dedicated computers. In some embodiments, the repository 210 may include one or more computers carrying out other functionality in addition to server operations. The repository 210 may store and provide any type of data used to segment and generate attribute labels. Such data may include, without limitation: flight plan data, graphical elements, symbols (e.g., symbology elements) and text appropriate for the presentation of various categories of aviation notice data, and other data compatible with the system 202.

In an example, the annotation system 202 may be located onboard the aircraft 204 and may communicate with the one or more communication devices 206 via wired or wireless communication connection. The annotation system 202 and the repository 210 may be disparately located and the annotation system 202 may communicate with the repository 210 via the network 212 and/or communication mechanisms onboard the aircraft 204.

The network 212 may be a satellite communication network enabling global connectivity for aircraft in flight, aeronautical radio network, like the Aeronautical Mobile Satellite Service (AMSS), facilitating air-to-ground communications, ground-based radio network, such as very high frequency (VHF) or high frequency (HF) radio systems used for air traffic control communications, Internet-based network using secure protocols for ground-based systems and operations, combination of multiple network types to ensure redundancy and global coverage.

The air traffic control (ATC) 208 center generally transmits aviation notices to the aircraft 204 that may include flight crew instructions and aircraft operations for performance during completion of a current flight plan. The ATC 208 may be an official air traffic control center, a ground control center, or any other ground-based entity communicating with the aircraft 204 before, during, and post-flight. Further, the ATC 208 may include more than one source of message transmissions. For example, the ATC 208 may be a combination of an air traffic control center, a ground control center, and additional ground-based personnel communicating with the aircraft.

During operation, the annotation system 202 may obtain aviation notices, such as NOTAMs from the ATC 208. The annotation system 202 may then process the aviation notices based on various machine learning models to identify the attributes and associate labels with each of the attributes. In an example, the annotation system 202 may present a new interface comprising graphical elements (including symbols) and texts associated with the aviation notices. The new interface may be presented on the one or more communication devices 206 onboard the aircraft 204. From the new interface, a user (e.g., a flight crew member) may study the labels to make decisions based on real-time conditions associated with the flight plan or environment.

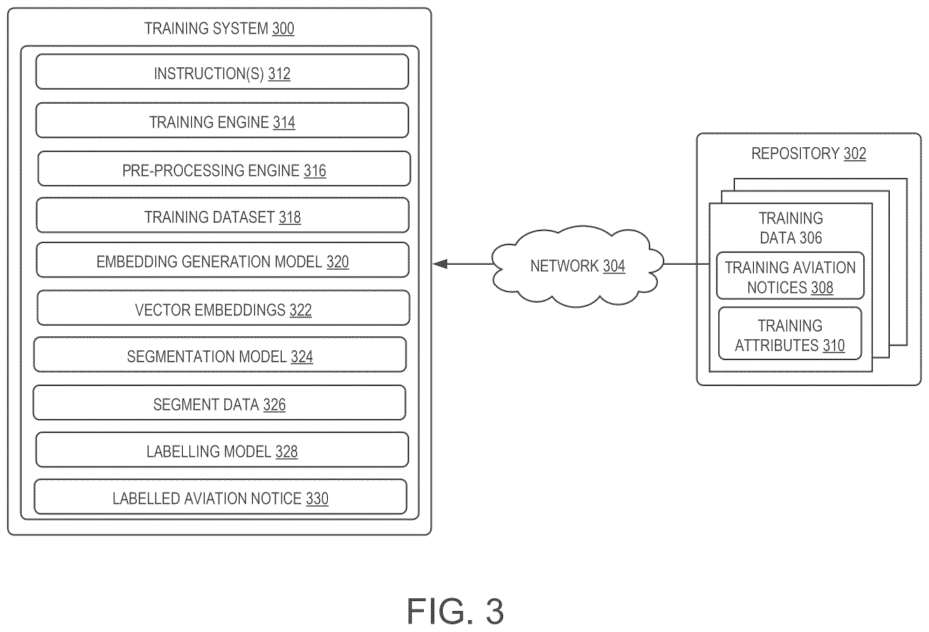

The annotation system 202 may implement one or more models to identify segments and associate labels with each label may have to be trained which is further explained in conjunction with FIG. 3. FIG. 3 illustrates a training system 300 comprising a processor or memory (not shown), for training the one or more models employed by the annotation system to generate labels with the aviation notices. In an example, the training system 300 (referred to as system 300) may be communicatively coupled to a repository 302, similar to the repository 210, through a network 304. The repository 302 may further include training data 306. The training data 306 may include training aviation notices 308 and training attributes 310 obtained from multiple NOTAMs downloaded from system wide information management (SWIM) of federal aviation administration (FAA).

In an example, the training aviation notices 308 may refer to a subset of aviation notices or NOTAMs (Notices to Air Missions) that are specifically selected or curated for use in training machine learning models or other analytical systems. The training aviation notices 308 may contain information relevant to flight operations, such as temporary flight restrictions, runway closures, navigational aid outages, or other important aviation-related information, which can be used to train systems to recognize, categorize, or process such notices effectively.

In an example, the training attributes 310 may refer to specific characteristics, features, or data points extracted from aviation notices or NOTAMs that are used to train machine learning models or other analytical systems. The training attributes 310 may include, but are not limited to, categories of information such as location identifiers, effective dates and times, event types, affected airspace, and other relevant details contained within the NOTAMs. The training attributes 310 may be structured in a format suitable for input into training algorithms, allowing the annotation system 202 to learn patterns, classifications, or other insights from the aviation notice data.

The training data 306, although depicted as being obtained from a single repository, such as repository 302, may also be obtained from multiple other sources without deviating from the scope of the present subject matter. In such cases, each of such multiple repositories may be interconnected through a network, such as the network 304. The network 304 may be similar to the network 212.

The system 300 may further include instructions 312 and a training engine 314. In an example, the instructions 312 are fetched from a memory and executed by a processor included within the system 300. The training engine 314 may be implemented as a combination of hardware and programming, for example, programmable instructions to implement a variety of functionalities. In examples described herein, such combinations of hardware and programming may be implemented in several different ways. For example, the programming for the training engine 314 may be executable by instructions, such as the instructions 312. Such instructions may be stored on a non-transitory machine-readable storage medium which may be coupled either directly with the system 300 or indirectly (for example, through networked means). In an example, the training engine 314 may include a processing resource, for example, either a single processor or a combination of multiple processors, to execute such instructions. In the present examples, the non-transitory machine-readable storage medium may store instructions, such as the instructions 312, that when executed by the processing resource, implement the training engine 314. In other examples, the training engine 314 may be implemented as electronic circuitry.

The instructions 312 when executed by the processing resource, cause the training engine 314 to train a pre-processing engine 316. In an example, the pre-processing engine 316 may be a rule-based engine that may perform data collection and pre-processing for the purposes of training one or more models implemented in the annotation system. The pre-processing engine 316 may obtain aviation notices, such as NOTAMs from the repository 302. In an example, the NOTAMs were retrieved from the FAA's SWIM system via a subscription-based access. Upon retrieving the NOTAMs, the pre-processing engine 316 may apply various rules to filter out various NOTAMs. For example, if a NOTAM, lacks valid subject or keywords, the pre-processing engine 316 may remove such NOTAM. In another example, if a NOTAM lacks valid start/end timestamps (such as not in a format: YYMMDDHHmm), the pre-processing engine 316 may remove such NOTAM. The pre-processing engine 316 may further perform text transformation to remove accountability, NOTAM number, airport name, schedule start and end time. Further, the pre-processing engine 316 may replace terms as “obs at” and schedule start/end information with “datetime” keyword. In addition, the pre-processing engine 316 may convert all characters to lowercase.

Based on the above, the pre-processing engine 316 may generate a training dataset 318 for training the one or more models. The training dataset 318 may include nine different types of NOTAMs as indicated in Table 1 below.

TABLE 1

| Subject | RWY | TWY | APRON | OBST | AIRSPACE | NAV | AD | SVC | COM |
|---|---|---|---|---|---|---|---|---|---|
| Count | 1,41,132 | 94,793 | 57,149 | 39,231 | 19,743 | 17,152 | 14,225 | 7,344 | 3,067 |

The instructions 312 when executed by the processing resource, cause the training engine 314 to train an embedding generation model 320. The training engine 314 used the training dataset to train the embedding generation model 320. In an example, the embedding generation model 320 is a natural language processing model, such as a Bidirectional Encoder Representations from Transformers (BERT) model. The training engine 314 may train the BERT model on NOTAM data to create embeddings that capture the unique language and structure of aviation notices.

In an example, the training engine 314 may create word-level NOTAM tokens with a vocabulary of 29,999 terms. The training engine 314 may use the different types of NOTAMs indicated in Table 2 for creating the word-level NOTAM tokens. In an example, the training engine 314 may employ different techniques, such as, but not limited to, frequency-based methods, term frequency-inverse document frequency (TF-IDF), and byte pair encoding (BPE) to create the word-level NOTAM tokenizer.

Once the word-level NOTAM tokens are created, the training engine 314 may train the BERT model using the word-level tokens. In an example, the training engine 314 may use a Masked Language Modelling (MLM) technique where some words in the aviation notices are masked. The BERT model may learn to predict these masked words. In an example, the BERT model may be trained on approximately 4M trainable parameters. The BERT model may include 128 hidden units, 2 layers, and 2 attention heads. The BERT model may have an intermediate size of 512 which represents the number of neurons in the feed-forward layers, which process the output from the self-attention mechanism in each transformer block.

Upon training the embedding generation model 320, such as the BERT model, the embedding generation model 320 may generate a plurality of vector embeddings 322 for the word-level NOTAM tokens. The vector embeddings 322 may indicate vector representations of NOTAM tokens that capture semantic and contextual meaning of the NOTAM tokens within the specialized domain of aviation notices. The vector embeddings 322 encode information about: meaning of a token in various NOTAM contexts, relationships between different NOTAM terms and concepts, domain-specific usage patterns across different types of NOTAMs, subtle variations in meaning based on surrounding context. For obtaining the vector embeddings 322, the training engine 314 may use a concatenation of the last two layers of the BERT model rather than aggregating all the layers.

Further, the training engine 314 may obtain annotated NOTAMs which provides multiple segment boundary examples. A “segment” may refer to an attribute within a NOTAM. Thus, segments represent distinct parts of the NOTAM that convey specific types of information. For example, a NOTAM might contain segments such as keyword or identifier, location information, condition or status description, time period, additional details or instructions. Based on the annotated NOTAMs, the training engine 314 may train the segmentation model 324. In an example, the segmentation model 324 may be a recurrent neural network (RNN) model, such as a bidirectional long short term memory (BILSTM) model. In the present subject matter, the segmentation model 324 is trained on a limited set of annotated NOTAMs. For example, the segmentation model 324 may be trained on a limited types of NOTAMs, such as (TWY) NOTAMs, runway (RWY) NOTAMS, and designated area (APRON) NOTAMs.

In an example, the training engine 314 may provide the annotated NOTAMs and the vector embeddings 322 generated by the BERT model as an input to the BILSTM model. Based on the vector embeddings 322, the BILSTM model may perform segment boundary identification. For example, the BILSTM model may predict whether each token marks the end of a current segment. In an example, the segmentation model 324 may determine pairwise distances between the vector embeddings of consecutive tokens to identify when there is a change in segments.

Upon training, the segmentation model 324 may identify segment boundaries even for NOTAM types on which the segmentation model 324 was not explicitly trained on. The information about the segment boundaries and segments may be stored as segment data 326. Table 2 depicts the segmentation performance of the segmentation model 324 for each type of NOTAM, including both the types the segmentation model was trained on (TWY, RWY, APRON) and the other 6 types the segmentation model 324 was not explicitly trained on. Specifically, the BILSTM model was trained on 250 NOTAMs from TWY, RWY, and APRON types. Thereafter, the BILSTM model was tested on 180 NOTAMs, which included examples from all 9 NOTAM types.

TABLE 2

| | NOTAM Type | | | | | | | | |
|---|---|---|---|---|---|---|---|---|---|
| | RWY | TWY | APRON | OBST | AIRSPACE | NAV | AD | SVC | COM |
| F1 Score | 0.97 | 0.95 | 0.98 | 0.76 | 0.77 | 0.85 | 0.75 | 0.76 | 0.73 |
| Precision | 0.97 | 0.99 | 0.96 | 0.71 | 0.79 | 0.81 | 0.82 | 0.67 | 0.62 |
| Recall | 0.97 | 0.92 | 1 | 0.82 | 0.75 | 0.88 | 0.7 | 0.87 | 0.89 |

Table 2 illustrates an example depicting the F1 Score, Precision, and Recall for each of these 9 NOTAM types when performing segment boundary classification. As may be clearly seen from Table 3, the BILSTM model performs best on RWY, TWY, and APRON NOTAMs, with F1 scores of 0.97, 0.95, and 0.98 respectively. Further, performance of the BILSTM model is lower but reasonable for other NOTAM types (OBST, AIRSPACE, NAV, AD, SVC, COM), with F1 scores ranging from 0.73 to 0.85. 3. The precision and recall values generally follow the F1 score trends across NOTAM types.

Based on the training, the segmentation performance of the BILSTM model for specific attributes across different training sample sizes was determined. Table 3 below depicts the performance of the trained BILSTM model.

TABLE 3

| Training | | | | | | Other | | Surface | Type of |
|---|---|---|---|---|---|---|---|---|---|
| Sample Size | KWD | Designator | Facility | Condition | Coordinates | Comments | Location | Segment | Obstruction |
| 50 | 0.97 | 0.95 | 0.98 | 0.76 | 0.77 | 0.85 | 0.75 | 0.76 | 0.73 |
| 150 | 0.97 | 0.99 | 0.96 | 0.71 | 0.79 | 0.81 | 0.82 | 0.67 | 0.62 |
| 250 | 0.97 | 0.92 | 1 | 0.82 | 0.75 | 0.88 | 0.7 | 0.87 | 0.89 |

It may be noted that the numbers in the Tables are only exemplary and are not intended to limit the scope of the claimed subject matter in any manner.

Specifically, Table 3 demonstrates the segmentation model's ability to effectively segment different types of NOTAMs and identify various attributes, with performance generally improving as more training data is provided. For example, as depicted in Table 3, performance of the segmentation model 324 improves. Common attributes like KWD (keyword), Designator, and Condition show high F1 scores (0.91-0.96) with 250 training samples. Some attributes (e.g., Surface Segment) show significant improvement with more training data, going from 0.22 F1 score with 50 samples to 1.00 with 250 samples. Certain attributes (e.g., Type of obstruction) show consistent performance (0.57 F1 score) regardless of training sample size.

Further, the training engine 314 may train a labelling model 328, such as a Conditional Random Field (CRF) model, to associate labels with the attributes associated with each aviation notice. The CRF model may be trained on a limited set of annotated NOTAMs (e.g., 45, 90, or 250). During training, the CRF model may learn to associate specific patterns of features with particular attribute labels.

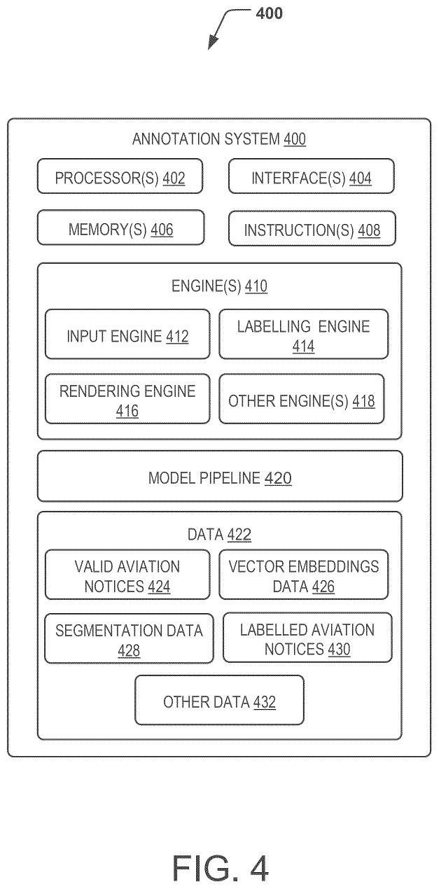

In an example, the training engine 314 may provide the vector embeddings 322 and the segment data 326 as an input to the CRF model. The CRF model incorporates various features derived from the NOTAM text and the segment information. For example, the CRF model may include contextual embeddings for neighbouring tokens, segment boundary information for current and neighbouring tokens, domain-specific features such as presence of specific strings (‘pct’, ‘in’, ‘ft’), token characteristics (digit, alphanumeric, presence of special characters), and position information (e.g., if a token is at the end of an attribute segment). The CRF model may consider the entire sequence of tokens, using the integrated features to model dependencies between labels. Based on the above, the labelling model 328 is trained to perform sequence labelling. In an example, the labelling model 328 may use B-I-O (Begin-Inside-Outside) encoding scheme to label each token. The CRF model optimizes the labelling for the entire sequence jointly, rather than making independent decisions for each token. The label data pertaining to various attributes is stored as labelled aviation notice 330. The manner in which the labels are generated for various attributes of the aviation notices is further described in conjunction with FIG. 4.

FIG. 4 illustrates a annotation system 400 for generating attribute labels for aviation notices, according to an example. In an example, the annotation system 400 (referred to as system 400) may create vector embeddings based on context of aviation notices using the trained embedding generation model 320. Further, the system 400 may identify segment boundaries in the aviation notices using the trained segmentation model 324. In addition, the system 400 may generate attribute labels with each segment using the trained labelling model 328. In an example, the embedding generation model 320, the segmentation model 324, and the labelling model 328, in context of this example, are trained based on attributes associated with various aviation notices.

The system 400 may include a processor 402, interface(s) 404, and memory 406. The processor 402 may be implemented as microprocessors, microcomputers, microcontrollers, digital signal processors, central processing units, state machines, logic circuitries, and/or other devices that manipulate signals based on operational instructions. Among other capabilities, the processor 402 may be configured to obtain a plurality of aviation notices from various data sources. The processor 402 may then pre-process the plurality of aviation notices using a rule-based engine to identify a valid set of aviation notices. In an example, the processor 402 may also be capable of generating vector embeddings, segmenting text of aviation notices, and labelling each segment using an embedding generation model, a segmentation model, and a labelling model, respectively.

The interface(s) 404 may allow the connection or coupling of the system 400 with one or more computing devices, such as avionic systems through a wired network, a wireless network, or a combination of a wired and wireless network. The interface(s) 404 may also enable intercommunication between different logical as well as hardware components of the system 400.

The memory 406 may be a computer-readable medium, examples of which include volatile memory (e.g., RAM), and/or non-volatile memory (e.g., Erasable Programmable read-only memory, i.e., EPROM, flash memory, etc.). The memory 406 may be an external memory, or internal memory, such as a flash drive, a compact disk drive, an external hard disk drive, or the like. The memory 406 may further include data which either may be utilized or generated during the operation of the system 400.

Similar to the system 100, the system 400 may further include instructions 408 and engine(s) 410. In an example, the instructions 408 are fetched from the memory 406 and executed by the processor 402 included within the system 400. The engine(s) 410 may include an input engine 412, a labelling engine 414, a rendering engine 416, and other engine(s) 418. The other engine(s) 418 may further implement functionalities that supplement functions performed by the system 400 or any of the engine(s) 410. The input engine 412, the labelling engine 414, and the rendering engine 416 may be implemented as a combination of hardware and programming, for example, programmable instructions to implement a variety of functionalities. In examples described herein, such combinations of hardware and programming may be implemented in several different ways. For example, the programming for the input engine 412, the labelling engine 414, and the rendering engine 416 may be executable instructions, such as instructions 408. Such instructions 408 may be stored on a non-transitory machine-readable storage medium which may be coupled either directly with the system 400 or indirectly (for example, through networked means). In an example, the input engine 412, the labelling engine 414, and the rendering engine 416 may include a processing resource, for example, either a single processor or a combination of multiple processors, to execute such instructions. In the present examples, the non-transitory machine-readable storage medium may store instructions, such as instructions 408, that when executed by the processing resource, implement the input engine 412, the labelling engine 414, and the rendering engine 416. In other examples, the input engine 412, the labelling engine 414, and the rendering engine 416 may be implemented as electronic circuitry.

The system 400 may further include a model pipeline 420. The model pipeline 420 may include the various models, such as the embedding generation model 320, the segmentation model 324, and the labelling model 328, that may be used by the engine(s) 410 to perform various operations related to generating attribute labels.

The system 400 may further include data 422. The data 422 may include corresponding data that is utilized or generated by the system 400, while performing a variety of functions. In an example, the data 422 further includes valid aviation notices 424, vector embeddings 426, segmentation data 428, labelled aviation notices 430, and other data 432. Further, the other data 432, amongst other things, may serve as a repository for storing data that is processed, or received, or generated as a result of the execution of the instructions by the processor 402.

In operation, initially, the input engine 412 may obtain a plurality of aviation notices. As explained above, an aviation notice may refer to an official communication or alert issued to inform aviation stakeholders about important information related to flight operations, airspace, airports, or other aviation-related matters. Examples of the aviation notice may include Notices to Airmen (NOTAM), Aeronautical Information Circulars (AICs), Pilot Reports (PIREPs), and so on. The aviation notices play a crucial role in maintaining the safety and efficiency of aviation operations by ensuring that all relevant parties have access to the most up-to-date and critical information. In an example, the input engine 412 may obtain the plurality of aviation notices from a repository, such as the repository 302 or directly from various terminal devices.

The input engine 412 may employ one or more pre-defined rules to extract a set of aviation notices. For example, the input engine 412 may extract the aviation notices that do not meet pre-defined criteria. For example, the input engine 412 may discard those aviation notices which lack valid subject or keywords or which lack valid start/end timestamps. Each aviation notice from the set of aviation notices may have a pre-defined format as per the guidelines of Federal Aviation Administration (FAA). The input engine 412 may store the set of aviation notices as the valid set of aviation notices 424. The valid aviation notices 424 may be used by the labelling engine 414 for further processing.

In an alternative example, instead of obtaining the aviation notices, the labelling engine 414 may directly obtain a plurality of tokens associated with the aviation notices. The labelling engine 414 may obtain the plurality of tokens from a repository, such as the repository 302. The tokens may represent individual units of the text that make up the aviation notice. These tokens are typically obtained by breaking down the text of the aviation notice into smaller, meaningful elements. For example, each word, number, abbreviation, etc. is represented by tokens.

Further, the labelling engine 414 may generate vector embeddings. In an example, the labelling engine 414 may generate the vector embeddings from the aviation notices or based on the plurality of tokens. The vector embeddings may indicate vector representations of text of aviation notices that capture semantic and contextual meaning of the aviation notices. Each of the plurality of vector embeddings is indicative of a word in the valid aviation notice. The labelling engine 414 may store the vector embeddings as the vector embedding data 426. In an example, the labelling engine 414 may employ the pre-trained natural language processing model, such as the embedding generation model 320, such as the BERT model, from the model pipeline 420 for generating the vector embeddings. The BERT model may identify semantic relationships within the plurality of tokens to generate the vector embeddings.

Further, the labelling engine 414 may identify one or more segments in the plurality of tokens. A “segment” may refer to an attribute within the aviation notice. To identify the one or more segments, the labelling engine 414 may provide the plurality of tokens as an input to a machine learning model, such as the segmentation model 324 from the model pipeline 420. The segmentation model 324 may be a pre-trained machine learning model on a set of attributes pertaining to flight related parameters pertaining to corresponding aviation notices. In an example, the machine learning model may be a natural language processing model, such as a BILSTM model, that may be trained to identify semantic relationships within the plurality of tokens. The machine learning model may first determine segment boundaries in the aviation notices. In an example, a segment boundary separates one attribute of the aviation notice from another attribute in the aviation notice. In an example, the labelling engine 414 may apply a recurrent neural network (RNN) to the plurality of vector embeddings to determine the segment boundaries. The labelling engine 414 may store information about the one or more segments as the segmentation data 428.

Further, the labelling engine 414 may associate at least one label with the attribute defined within each of the one or more segments to obtain labelled aviation notice. The labelling engine 414 may employ a sequence labelling model, such as a conditional random forest (CRF) model to associate the at least one label with the segments. In an example, based on the vector embeddings data 424 and the segmentation data 428, the CRF model may associate labels with each segment of the aviation notice. In an example, the CRF model may analyse the vector embeddings data 424 and the segmentation data 428 based on pre-defined rules. The pre-defined rules may include a mapping between attributes and corresponding labels based on aviation industry standards.

In an example, the pre-defined rules may indicate characteristics or patterns specific to the aviation domain that are manually engineered based on expert knowledge. Examples of the pre-defined rules for labelling include presence of domain-specific abbreviations or units (e.g., ‘pct’, ‘in’, ‘ft’), token type identification (e.g., digit, alphanumeric), presence of special characters relevant to aviation notices (e.g., ‘/’, ‘.’), contextual information from neighbouring tokens, specific character positions within tokens, token length, position of tokens within attribute segments, and so on. Based on the pre-defined rules, the CRF model may leverage both the semantic information from the vector embeddings and the structural information from segment boundaries and domain-specific patterns. The labelling engine 414 may accordingly generate labelled aviation notices 428 which are stored in the annotation system 400.

Further, the rendering engine 416 may transmit the labelled aviation notice to an avionic system. In an example, the avionic system may be a terminal device, such as an Electronic Flight Bag (EFB), Multi-Function Display (MFD), a Flight Management Systems (FMS), and so on. For example: a runway closure NOTAM labelled as “B-Runway” and “B-Condition: CLOSED” may be displayed on an airport diagram in the EFB, with the affected runway highlighted in red. In another example, a “B-Airspace” NOTAM about temporary restricted airspace may be automatically plotted on a navigation display and factored into route calculations.

In an example, the rendering engine 416 may incorporate a feedback mechanism to allows users to provide input on the accuracy of the labelled aviation notices generated by the labelling engine 414. For example, when a user reviews a labelled aviation notice, the users may be provided with an option to indicate whether the labels, categorization, or interpretation of the notice are correct or require adjustment. The processor 402 may collect and analyse this feedback, use the feedback to re-train the machine learning model's performance. By incorporating user feedback into the model's training process, the system 400 may continuously adapt and enhance its ability to accurately label and interpret aviation notices. This iterative learning approach may help to reduce errors over time, improve the model's understanding of complex or ambiguous notices, and ultimately increase the reliability and usefulness of the labelled aviation notices for all users of the system 400.

In an example, the rendering engine 416 may continuously monitor and process incoming data streams (aviation notices) to determine an update pertaining to the aviation notice. The rendering engine 416 may identify new information relevant to existing labelled aviation notices. Upon detecting such information, the processor 402 may automatically analyse the content of the incoming data streams, assess the impact of the content and seamlessly integrate the new content into the corresponding labelled aviation notice. Based on the update, the rendering engine 416 may perform real-time modification to the labelled aviation notice. The real-time modification may involve modifying existing fields, adding new information, or adjusting the assigned labels as necessary. The modified labelled aviation notice may then be transmitted to the avionic system.

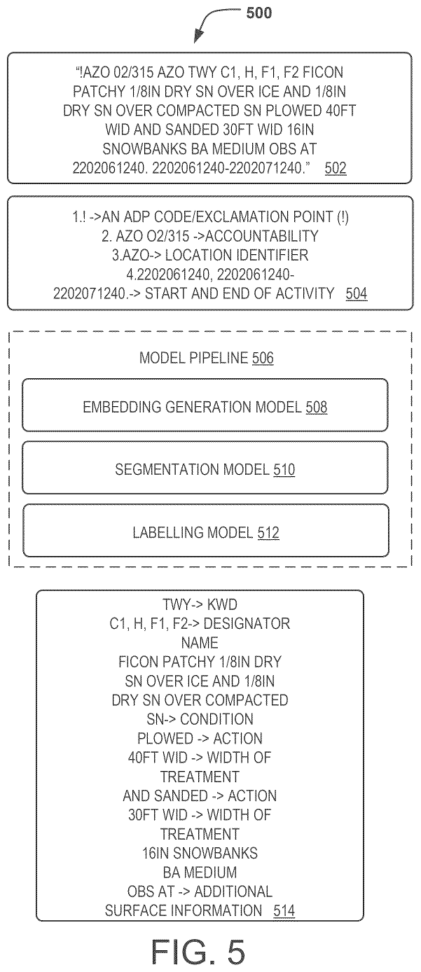

FIG. 5 illustrates an exemplary schematic block diagram 500 depicting generation of attribute labels for aviation notices, according to an example. The block diagram 500 shows a process flow for processing and labelling aviation notices, such as NOTAMs. The block diagram 500 may be performed by the annotation system 400.

In an example, an input aviation notice 502, which may be a raw NOTAM received from an aviation authority or other source. The system 400 may obtain the input aviation notice 502 may be obtained from various channels, such as official aviation communication networks, NOTAM distribution systems, or direct feeds from air traffic control centers. In an example, the input aviation notice 502 may be retrieved from a centralized database that collects and stores NOTAMs from multiple sources.

The aviation notice 502 is then subjected to a pre-processing step 504. The pre-processing step 504 helps to standardize the aviation notice, reduce noise, and prepare the aviation notice for more effective processing. This pre-processing step 504 may apply various rules to perform several operations to filter out various NOTAMs. Examples of the several operations, such as cleaning where any extraneous characters, whitespace, or formatting is removed. In an example, if a NOTAM, lacks valid subject OR keywords, the system 400 may remove such NOTAM. In another example, if a NOTAM lacks valid start/end timestamps (such as not in a format: YYMMDDHHmm), the system 400 may remove such NOTAM. The system 400 may further perform text transformation to remove accountability, NOTAM number, airport name, schedule start and end time. Further, the system 400 may replace terms as “obs at” and schedule start/end information with “datetime” keyword. In addition, the system 400 may convert all characters to lowercase.

In addition, during the pre-processing step 504, the system 400 may generate word-level tokens. For example, the system 400 may split text of the aviation notice 502 into individual words based on whitespace and punctuation. For example, “RWY 09/27 CLSD” might be tokenized as [“RWY”, “09/27”, “CLSD”]. The output of the tokenization is a structured representation of the aviation notice 502 that maintains its semantic integrity while enabling more granular analysis in the following stages of the attribute labelling pipeline.

Following tokenization, the tokens are subjected to a model pipeline 506 which involves natural language processing and multiple machine learning models. For example, the tokens are provided as an input to an embedding generation model 508, such as a BERT model. The BERT model may be fine-tuned on aviation-related corpus to generate dense vector representations that encode the meaning and relationships between tokens in the high-dimensional space. These embeddings capture not only the literal meaning of each token but also its contextual usage within aviation notices, allowing the system 400 to understand distinctions and similarities between terms that are crucial in the aviation domain.

The embedded tokens are then passed through a segmentation model 510, which may be implemented as a Bidirectional Long Short-Term Memory (BILSTM) neural network. The segmentation model 510 may be trained on a diverse corpus of annotated aviation notices, allowing the model 510 to generalize across various NOTAM types and structures, and to accurately identify segment boundaries even in complex or ambiguous cases. Thus, upon obtaining the embedded tokens, the segmentation model 510 may analyze the sequence of embedded tokens to identify segment boundaries within the aviation notice, effectively dividing the notice into distinct attributes or pieces of information. The BILSTM architecture allows the model to consider both past and future context when processing each token, enabling it to capture long-range dependencies and complex patterns within the aviation notice text. In an example, as the segmentation model 510 processes the sequence of embedded tokens, the segmentation model 510 may learn to recognize transitions between different types of information, such as shifts from location data to time information or from runway identifiers to operational status. The output of the segmentation model 510 is a sequence of tokens with predicted segment boundaries, effectively structuring the raw aviation notice into logical components that correspond to different attributes or information types relevant to aviation operations.

Once the segments are identified, a labelling model 512, which may be implemented as a Conditional Random Field (CRF) model, assigns appropriate labels to each identified segment. These labels categorize the different parts of the aviation notice according to their function or meaning within the context of aviation operations. The labelling model 512 may be trained on a diverse set of pre-labelled aviation notices, allowing the labelling model 512 to recognize and correctly label a wide range of attribute types, including but not limited to location identifiers, time periods, operational statuses, and specific aviation terminology.

The CRF model takes into account the sequence of segments, their content, and the relationships between adjacent segments to make informed labelling decisions. For example, the CRF model may consider features such as the semantic information from the embeddings, the position of the segment within the notice, and domain-specific patterns to accurately classify each segment.

The output of the labelling model 512 is a labelled aviation notice 514. This labelled aviation notice 514 contains the original information from the input aviation notice which has been structured and categorized in a way that facilitates easier interpretation and processing by avionic systems and aviation personnel. In an example, the labelled aviation notice 514 may be further processed or transmitted to relevant systems for use in flight planning, air traffic management, or other aviation-related activities. The structured format of the labelled aviation notice 514 may allow for more efficient integration of the information into various aviation systems and decision-making processes.

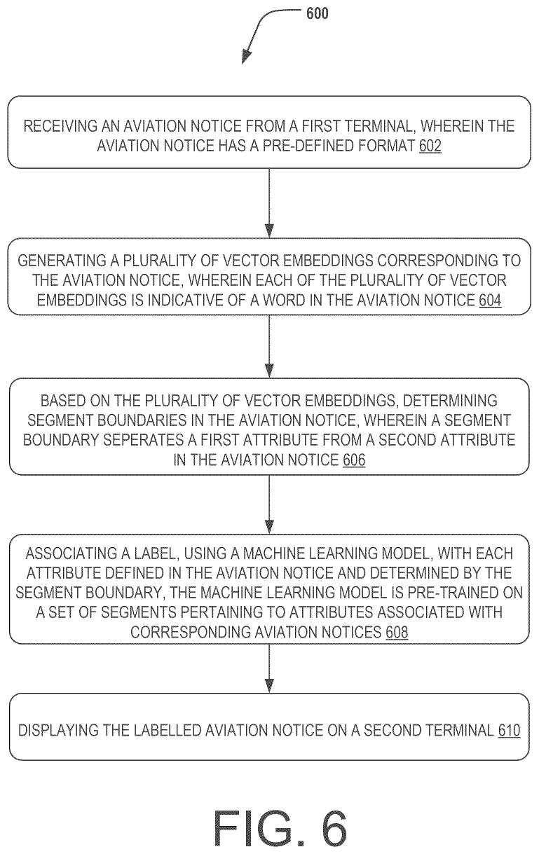

FIG. 6 illustrates example method 600 for generating attribute labels for aviation notices, according to an example. The order in which the method is described is not intended to be construed as a limitation, and any number of the described method blocks may be combined in any order to implement the methods, or an alternative method. Further, the method 600 may be implemented by processing resource or computing device(s) through any suitable hardware, non-transitory machine-readable instructions, or combination thereof.

It may also be understood that method 600 may be performed by programmed computing devices, such as the system 100, as depicted in FIG. 1. Furthermore, the method 600 may be executed based on instructions stored in a non-transitory computer-readable medium, as will be readily understood. The non-transitory computer-readable medium may include, for example, digital memories, magnetic storage media, such as one or more magnetic disks and magnetic tapes, hard drives, or optically readable digital data storage media. While the method 600 is described below with reference to the system 100 as described above; other suitable systems for the execution of these methods may also be utilized. Additionally, implementation of the method is not limited to such examples.

Referring to FIG. 6, at block 602, the method 600 includes receiving an aviation notice from a first terminal. The aviation notice may refer to an official communication or alert issued to inform pilots, air traffic controllers, and other aviation personnel about conditions, restrictions, or changes that may affect flight operations or safety. The aviation notice may contain information related to weather, airspace, airport facilities, navigation aids, or other operational factors relevant to aviation. Aviation notices may be issued by various authorities such as civil aviation organizations, air traffic control centers, meteorological services, or airport operators. These notices may be distributed through standardized formats and systems to ensure timely and widespread dissemination of critical information to the aviation community. Examples of the aviation notice may include, but are not limited to, notice to airmen (NOTAM), significant meteorological information (SIGMET), temporary flight restriction (TFR), and so on. Therefore, the aviation notices have a pre-defined format. In an example, the input engine 412 may receive the aviation notice.

In an example, the term “first terminal” may refer to a device, system, or interface capable of receiving, transmitting, or processing aviation notices. The first terminal may be a physical hardware device or a software application that serves as a point of entry or distribution for aviation-related information. Examples of a first terminal may include, but are not limited to, an air traffic control workstation, a ground-based computer system at an airport or aviation authority office, a mobile device or tablet used by ground crew or airport operations staff, a networked server that acts as a central hub for collecting and distributing aviation notices from multiple sources, and so on.

At block 604, the method 600 may include generating a plurality of vector embeddings corresponding to the aviation notice. Each of the plurality of vector embeddings is indicative of a word in the aviation notice. The vector embeddings may indicate vector representations of the aviation notice that capture semantic and contextual meaning of the aviation notice. The vector embeddings encode information about meaning of an aviation notice, relationships between different aviation terms and concepts, domain-specific usage patterns across different types of aviation notices, subtle variations in meaning based on surrounding context, and so on. In an example, the labelling engine 414 may generate the plurality of vector embeddings. For example, the labelling engine 414 may employ a natural language processing model, such as a Bidirectional Encoder Representations from Transformers (BERT) model, for generating the plurality of vector embeddings.

At block 606, the method 600 may include determining segment boundaries in the aviation notice based on the plurality of vector embeddings. A “segment” may indicate an attribute within an aviation notice that convey specific types of information. Thus, a segment boundary separates a first attribute from a second attribute in the aviation notice. In an example, the labelling engine 414 may employ a machine learning model, such as a bidirectional long short term memory (BILSTM) model, to determine segment boundaries. The BILSTM model may predict end of a current segment based on the vector embeddings. In an example, the BILSTM model may determine pairwise distances between the vector embeddings to identify when there is a change in segments.

At block 608, the method 600 may include associating a label with each attribute defined in the aviation notice and determined by the segment boundary. In an example, the labelling engine 414 may use a machine learning model to associate the label with each attribute. The label may indicate an identifier that may categorize a specific piece of information within the aviation notice. The machine learning model may be pre-trained on a set of segments pertaining to attributes associated with corresponding aviation notices. As a result, the machine learning model may make informed labelling decisions by leveraging both semantic context and structural information, even with limited training data.

Further, at block 610, the method 600 includes displaying the labelled aviation notice on a second terminal. In an example, the rendering engine 416 may display the labelled aviation notice on the second terminal. As may be understood, the second terminal may refer to a device, system, or interface capable of receiving, displaying, or interacting with labelled aviation notices. Examples of the second terminal may include but are not limited to Electronic Flight Bag (EFB), Pilot Briefing System, a mobile device, aircraft Multi-Function Display (MFD), a web-based dashboard accessible to airport management staff for monitoring relevant labelled notices, or any other avionic system. The rendering engine 416 may present the labelled aviation notice in a structured, easily interpretable format, with key information highlighted or categorized based on the labels assigned during processing. This improved display format helps aviation professionals to quickly identify and understand critical information relevant to their operations. The present subject matter therefore facilitates easier processing, analysis, and utilization of the NOTAM data by various aviation systems and personnel.

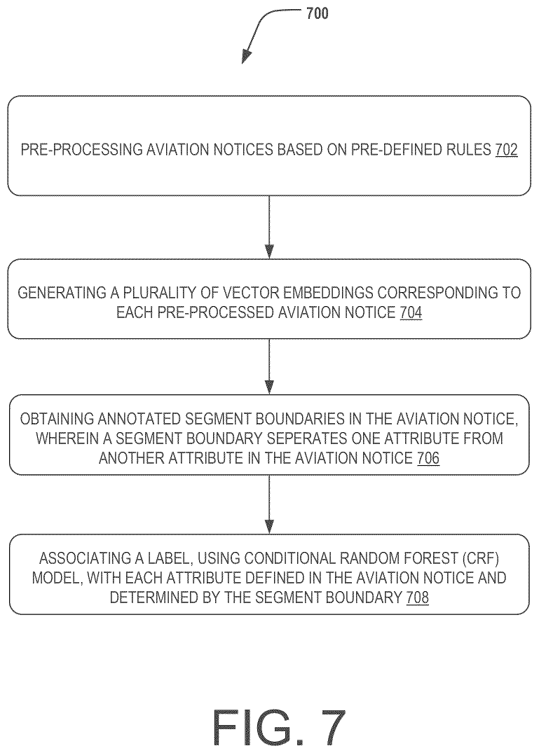

FIG. 7 illustrates a method 700 for training an annotation system for generating attribute labels, according to an example. It may be understood that method 700 may be performed by programmed computing devices, such as the system 300, as depicted in FIG. 3. The present example method illustrates training of an annotation system, based on one or more models. It is pertinent to note that such training may not occur separately and may be implemented in continuity with label generation without deviating from the scope of the present subject matter.

At block 702, the method 700 includes pre-processing aviation notices based on pre-defined rules. In an example, the pre-processing engine 316 may pre-process the aviation notices. The pre-processing engine 316 may be a rule-based engine that may perform data collection and pre-processing for the purposes of training one or more models implemented in the annotation system 400. The pre-processing engine 316 may obtain aviation notices, such as NOTAMs from a repository, such as the repository 302. The pre-processing may include extracting fixed attributes from the aviation notices. In an example, the training engine 314 may train the pre-processing engine 316 to remove standardized information that may be easily extracted using pattern matching, such as accountability information, NOTAM number, airport name, schedule start and end time information, and so on. The accountability information may refer to standardized metadata or administrative details included in NOTAMs that may be easily extracted without complex processing. The accountability information may include the issuing authority or organization responsible for the NOTAM, contact information for the issuing authority, date and time of NOTAM issuance, NOTAM series or classification codes, any reference numbers or identifiers linking the NOTAM to previous notices.

Further, the pre-processing may include replacing standard phrases with keywords. In an example, the training engine 314 may train the pre-processing engine 316 to replace standard phrases, such as “obs at” and scheduled start/end information with a “datetime” keyword. In another example, pre-processing engine 316 may be trained to replace “EST” (estimated) followed by time with “datetime approximate”.

In addition, the pre-processing may include filtering aviation notices with invalid subject and keywords. In an example, the training engine 314 may train the pre-processing engine 316 to discard the aviation notices that do not include essential information or do not conform to expected standards. The pre-processing engine 316 may ensure that a valid NOTAM should have a clear subject that falls within predefined categories, such as RWY (Runway), TWY (Taxiway), AIRSPACE (Airport), and so on. The pre-processing engine 316 may also be trained to check for appropriate combination of subject and keywords. By filtering out NOTAMs with invalid subjects and keywords, the annotation system 400 may ensure that only relevant and properly formatted notices are processed further, improving the efficiency and accuracy of subsequent NLP tasks.

Further, the pre-processing may include removing aviation notices with invalid timestamp. In an example, the training engine 314 may train the pre-processing engine 316 to remove NOTAMs that do not contain valid start/end times in a pre-defined format, such as YYMMDDHHmm. By removing NOTAMs with invalid timestamps, the annotation system may ensure that all processed NOTAMs have consistent and reliable time information, subsequent processing steps can rely on a standardized time format, the risk of errors in time-sensitive operations is reduced, data quality for analysis and decision-making is improved.

Finally, the pre-processing may include converting all characters to lowercase. In an example, the training engine 314 may convert all text to lowercase to create a uniform representation of the aviation notice. Thus, by pre-processing the aviation notices, the annotation system 400 may reduce noise and inconsistencies in the dataset, thereby creating a uniform representation of the NOTAM data. These advantages collectively contribute to a more robust, efficient, and accurate system for processing and analysing aviation notices.

Referring back to FIG. 7, at block 704, the method 700 includes generating a plurality of vector embeddings corresponding to each pre-processed aviation notice. To generate the plurality of vector embeddings, the training engine 314 may train an embedding generation model, such as the embedding generation model 320. In an example, the embedding generation model 320 is a natural language processing model, such as a Bidirectional Encoder Representations from Transformers (BERT) model. In an example, the training engine 314 may use different types of aviation notices, such as NOTAMs to create a word-level NOTAM tokenizer. Once the word-level NOTAM tokenizer is created, the training engine 314 may train the BERT model using the word-level tokens. In an example, the BERT model may be trained on approximately 4M trainable parameters. The BERT model may include 128 hidden units, 2 layers, and 2 attention heads.

Upon training the embedding generation model 320, such as the BERT model, the embedding generation model 320 may generate a plurality of vector embeddings for the word-level NOTAM tokens. The vector embeddings may indicate vector representations of NOTAM tokens that capture semantic and contextual meaning of the NOTAM tokens within the specialized domain of aviation notices.

At block 706, the method 700 may include obtaining annotated segment boundaries in the aviation notices. In an example, the training engine 314 may obtain the annotated segment boundaries. A “segment” may refer to an attribute within a NOTAM and a segment boundary separates one attribute from another attribute in the aviation notice. Thus, segments represent distinct parts of the NOTAM that convey specific types of information. For example, a NOTAM might contain segments, such as keyword or identifier, location information, condition or status description, time period, additional details or instructions. Based on the annotated NOTAMs, the training engine 314 may train a segmentation model, such as the segmentation model 324. In an example, the segmentation model 324 may be a recurrent neural network (RNN) model, such as a bidirectional long short term memory (BiLSTM) model. In the present subject matter, the segmentation model 324 is trained on a limited set of annotated NOTAMs.

In an example, the training engine 314 may provide the annotated NOTAMs and the vector embeddings generated by the BERT model as an input to the BILSTM model. Based on the vector embeddings, the BILSTM model may perform segment boundary identification. For example, the BILSTM model may predict whether each token marks the end of a current segment.

At block 708, the method 700 may include associating a label with each attribute defined in the aviation notice and determined by the segment boundary. In an example, the training engine 314 train a labelling model, such as a Conditional Random Field (CRF) model, to associate labels with the attributes associated with each aviation notice. In an example, the training engine 314 may provide the vector embeddings and the segment boundaries as an input to the CRF model. The CRF model incorporates various features derived from the NOTAM text and the segment information. Based on the above, the labelling model may be trained to perform sequence labelling.

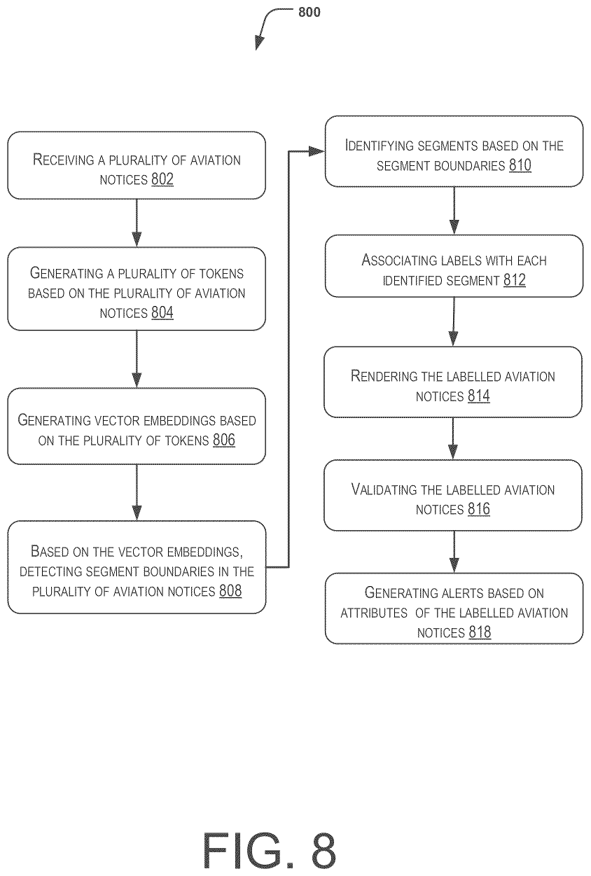

FIG. 8 illustrates example method 800 for generating attribute labels for aviation notices, according to another example. The order in which the method is described is not intended to be construed as a limitation, and any number of the described method blocks may be combined in any order to implement the methods, or an alternative method. Further, the method 800 may be implemented by processing resource or computing device(s) through any suitable hardware, non-transitory machine-readable instructions, or combination thereof. It may also be understood that method 800 may be performed by programmed computing devices, such as the system 400, as depicted in FIG. 4. While the method 800 is described below with reference to the system 400 as described above; other suitable systems for the execution of these methods may also be utilized. Additionally, implementation of the method is not limited to such examples.

Referring to FIG. 8, at block 802, the method 800 includes receiving a plurality of aviation notices. As explained earlier, the aviation notice may be a NOTAM. In an example, the input engine 412 may obtain aviation notices from various sources, such as air traffic control systems, aviation authorities, or centralized databases. In an example, the input engine 412 may pre-process the aviation notices to filter out redundant or invalid aviation notices. For example, the input engine 412 may receive a NOTAM stating “IFDC 3/8145 ZJX AIRSPACE JACKSONVILLE CENTER TEMPO FLIGHT RESTRICTIONS WI AN AREA DEFINED AS 3NM RADIUS OF 302719N/0813655W (OMN168015) SFC-3000 FT EFFECTIVE 1303170000 UTC UNTIL 1303172359 UTC”. The input engine 412 may filter out redundant or invalid notices, such as those with expired timestamps or missing crucial information.

At block 804, the method 800 includes generating a plurality of tokens based on the plurality of aviation notices. In an example, the labelling engine 414 may generate the plurality of tokens. The labelling engine 414 may break down the text of each aviation notice into individual words, numbers, or symbols. The tokenization process may consider aviation-specific abbreviations and terminology to ensure accurate representation of the notice content. For example, the labelling engine 414 may tokenize the NOTAM into individual elements: [“!FDC”, “3/8145”, “ZJX”, “AIRSPACE”, “JACKSONVILLE”, “CENTER”, “TEMPO”, “FLIGHT”, “RESTRICTIONS”, “WI”, “AN”, “AREA”, “DEFINED”, “AS”, “3NM”, “RADIUS”, “OF”, “302719N/0813655W”, “(OMN168015)”, “SFC-3000 FT”, “EFFECTIVE”, “1303170000”, “UTC”, “UNTIL”, “1303172359”, “UTC”].

At block 806, the method 800 may include generating vector embeddings based on the plurality of tokens. In an example, the labelling engine 414 may generate the vector embeddings. The labelling engine 414 may use a natural language processing model, such as BERT model, that may be pre-trained on a plurality of word-level tokens associated with different types of aviation notices. The BERT model may convert each token into a high-dimensional vector representation. For instance, “AIRSPACE” may be represented as a 768-dimensional vector: [0.1, −0.3, 0.5, . . . , 0.2]. These vector embeddings may capture semantic and contextual information about each token within the aviation domain.

At block 808, the method 800 includes detecting segment boundaries in the plurality of aviation notices based on the vector embeddings. In an example, the labelling engine 414 may detect the segment boundaries. In an example, the labelling engine 414 may apply a recurrent neural network (RNN) model to the plurality of vector embeddings. In an example, the RNN model is pre-trained using a plurality of annotations of aviation notices such that each annotation is indicative of a segment of the aviation notice. The RNN model may analyse the sequence of vector embeddings and identify points where one attribute or piece of information transitions to another within the aviation notice. For example, based on the vector embeddings, the BiLSTM model may detect a boundary between “JACKSONVILLE CENTER” (location information) and “TEMPO FLIGHT RESTRICTIONS” (restriction type).

At block 810, the method 800 includes identifying segments based on the segment boundaries. In an example, the labelling engine 414 may delineate distinct sections within each aviation notice based on the detected boundaries. Each segment may represent a specific attribute or type of information relevant to the notice, such as location, time period, or condition description. The labelling engine 414 may delineate distinct sections within the NOTAM, such as segment 1: “IFDC 3/8145 ZJX AIRSPACE JACKSONVILLE CENTER”, segment 2: “TEMPO FLIGHT RESTRICTIONS”, segment 3: “WI AN AREA DEFINED AS 3NM RADIUS OF 302719N/0813655W (OMN168015)”, and so on.

At block 812, the method 800 includes associating labels with each identified segment. In an example, the labelling engine 414 may employ a machine learning model, such as the CRF model, to assign appropriate labels to each segment based on the content and context within the aviation notice. The labels may categorize the information contained in each segment, making it easier to interpret and process. The labelling engine 414 may assign labels to each segment such as, segment 1: “NOTAM_IDENTIFIER”, segment 2: “RESTRICTION_TYPE”, segment 3: “AFFECTED_AREA”, segment 4: “VERTICAL_LIMITS”, and so on.

At block 814, the method 800 includes rendering the labelled aviation notices. In an example, the rendering engine 416 may present the processed and labelled aviation notices in a user-friendly format. The labelled aviation notices may be displayed on various aviation systems or interfaces, potentially highlighting or organizing information based on the assigned labels to enhance readability and comprehension for aviation professionals. The rendering engine 416 may display the labelled NOTAM in a structured format. For example, the labelled aviation notice may include labels for different attributes, such as NOTAM_IDENTIFIER: FDC 3/8145 ZJX AIRSPACE JACKSONVILLE CENTER, RESTRICTION_TYPE: Temporary Flight Restrictions, AFFECTED_AREA: Within 3NM radius of 302719N/0813655W (OMN168015), and so on. The structured format of the aviation notices may allow aviation professionals to quickly identify and comprehend the key information contained in the NOTAM.

Further, at block 816, the method 800 may include validating the labelled aviation notice against a set of pre-defined rules specific to the pre-defined format of the aviation notice. For example, the system 400 may apply a set of pre-defined rules specifically tailored to the expected format and content of the type of the aviation notice. These rules may check for proper syntax, required fields, valid data ranges, and logical consistency within the labelled notice. The validation process may help identify any discrepancies or errors that might have occurred during the labelling process, ensuring that the final output adheres to established standards and protocols for aviation notices. If any violations of these rules are detected, the system 400 may flag the notice for review or automatically attempt to correct the issues based on pre-defined correction protocols.

At block 818, the method 800 may include generating alerts based on specific attributes or combinations of attributes in the labelled aviation notice. In an example, the system 400 may automatically trigger alerts to relevant stakeholders or systems. These alerts may be customized based on the nature and urgency of the information, potentially including visual cues, audible notifications, or direct messages to designated personnel. In an example, the alerts may be configurable to accommodate various scenarios, such as severe weather warnings, airspace restrictions, or equipment malfunctions, enabling rapid dissemination of critical information to enhance situational awareness and support timely decision-making in aviation operations.

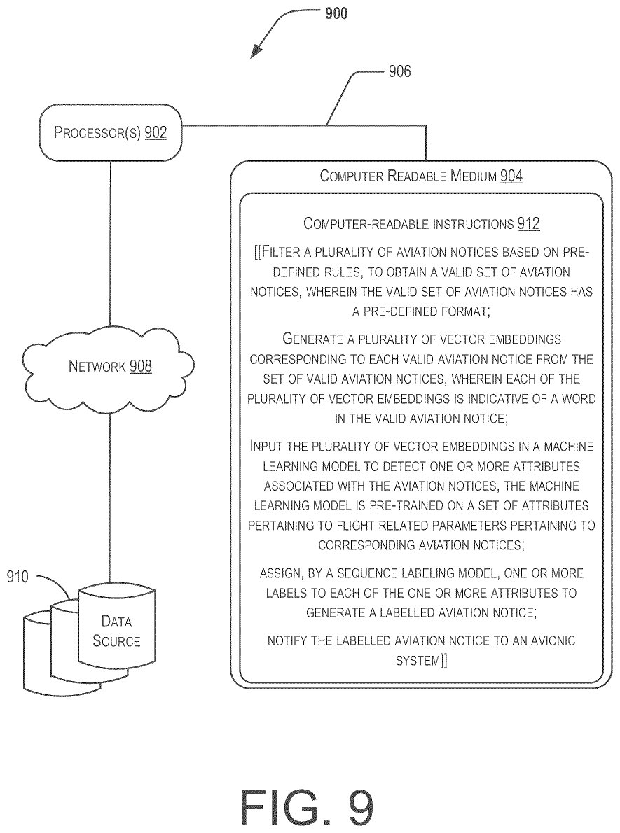

FIG. 9 illustrates a computing environment 900 implementing a non-transitory computer-readable medium for generating attribute labels for aviation notices, according to an example. In an example, the computing environment 900 includes processor(s) 902 communicatively coupled to a non-transitory computer readable medium 904 through a communication link 906. In an example implementation, the computing environment 900 may be for example, the system 100. In an example, the processor(s) 902 may have one or more processing resources for fetching and executing computer-readable instructions from the non-transitory computer readable medium 904. The processor(s) 902 and the non-transitory computer readable medium 904 may be implemented, for example, in system 100 (as has been described in conjunction with the preceding figures).

The non-transitory computer readable medium 904 may be, for example, an internal memory device or an external memory device. In an example implementation, the communication link 906 may be a network communication link. The processor(s) 902 may access the non-transitory computer readable medium 904 through a network 908. The network 908 may be a single network or a combination of multiple networks and may use a variety of communication protocols. The processor(s) 902 and the non-transitory computer readable medium 904 may also be communicatively coupled to a data source 910 over the network 908. The data source 910 may include, for example, a repository.

In an example, the non-transitory computer readable medium 904 includes a set of computer readable instructions 912 (referred to as instructions 912) which may be accessed by the processor(s) 902 through the communication link 906. Referring to FIG. 9, in an example, the non-transitory computer readable medium 904 includes instructions 912 that cause the processor(s) 902 to perform operations for generating attribute labels for aviation notices. The instructions 912 may be executed to filter a plurality of aviation notices based on pre-defined rules to obtain a valid set of aviation notices. An aviation notice may refer to an official communication or alert issued to inform pilots, air traffic controllers, and other aviation personnel about conditions, restrictions, or changes that may affect flight operations or safety. The aviation notice may contain information related to weather, airspace, airport facilities, navigation aids, or other operational factors relevant to aviation. The aviation notices may be distributed through standardized formats and systems to ensure timely and widespread dissemination of critical information to the aviation community. Examples of the aviation notice may include, but are not limited to, notice to airmen (NOTAM), significant meteorological information (SIGMET), temporary flight restriction (TFR), and so on.

In an example, the processor(s) 902 may receive a plurality of aviation notices. Further, the processor(s) 902 may employ one or more extraction rules to filter a set of aviation notices. For example, the processor(s) 902 may filter out the aviation notices that do not meet pre-defined criteria. For example, the processor(s) 902 may discard those aviation notices which lack valid subject or keywords, or which lack valid start/end timestamps. Each aviation notice from the set of aviation notices may have a pre-defined format as per the guidelines of Federal Aviation Administration (FAA).

Upon obtaining the valid set of aviation notices, the instructions 912 may cause the processor(s) 902 to generate a plurality of vector embeddings corresponding to each valid aviation notices. Each of the plurality of vector embeddings is indicative of a word in the valid aviation notice. To generate the vector embeddings, the processor(s) 902 may create tokens corresponding to each word of the aviation notice. Based on the word-level tokens, the processor(s) 902 may generate the plurality of vector embeddings. The vector embeddings may refer to numerical representations of words, phrases, or tokens from aviation notices in a high-dimensional vector space. These vector embeddings capture semantic and contextual information about each token within the specialized domain of aviation notices. The vector embeddings may be generated using natural language processing models, such as BERT, and may encode information about the meaning of a token in various aviation notice contexts, relationships between different aviation terms and concepts, domain-specific usage patterns across different types of notices, and subtle variations in meaning based on surrounding context. Each vector embedding may represent a token as a series of numerical values, allowing for mathematical operations and comparisons to be performed on the textual data of aviation notices.

Upon generating the plurality of vector embeddings, the instructions 912 may cause the processor(s) 902 to input the plurality of vector embeddings in a machine learning model to detect one or more attributes associated with the aviation notices. In an example, the machine learning model is pre-trained on a set of attributes pertaining to flight related parameters pertaining to corresponding aviation notices. In an example, the machine learning model may be a recurrent neural network (RNN) model, such as a bidirectional long short term memory (BILSTM) model. To detect the one or more attributes, the machine learning model may initially detect segment boundaries in the aviation notices, based on the vector embeddings. For example, the BILSTM model may predict whether each token marks the end of a current segment. Based on the segment boundaries, the BILSTM model may detect segments indicative of different attributes in the aviation notices.

Additionally, the instructions 912 may cause the processor(s) 902 to assign one or more labels to each of the one or more attributes to generate a labelled aviation notice. In an example, the processor(s) 902 may use a sequence labeling model, such as a conditional random forest (CRF) model to assign labels with the attributes of the aviation notices. The CRF model may use the vector embeddings and the segment boundaries as an input to generate labels with the attributes. The CRF model may extract various features from the input. For example, the features include contextual embeddings for neighbouring tokens, segment boundary information for current and neighbouring tokens, and so on. Further, the CRF model may consider the entire sequence of tokens, using the integrated features to model dependencies between labels.

In an example, the processor(s) 902 may re-train the CRF model based on feedback received regarding the accuracy of the labelled aviation notice. In an example, the processor(s) 902 may allow users to provide input on the accuracy of the labelled aviation notices. For example, when a user reviews a labelled aviation notice, the users may be provided with an option to indicate whether the labels, categorization, or interpretation of the notice are correct or require adjustment. The processor(s) 902 may collect and analyse this feedback, use the feedback to refine and improve the CRF model's performance.

The instructions 912 may cause the processor(s) 902 to notify the labelled aviation notice to an avionic system. In an example, the processor(s) 902 may transmit the processed and labelled NOTAM to relevant avionic systems on board an aircraft or to ground-based aviation management systems. The labelled aviation notice contains critical information that has been segmented and categorized, making it easier for pilots, air traffic controllers, and other aviation personnel to quickly comprehend and act upon.

In an example, the instructions 912 may cause the processor(s) 902 to analyze the content and attributes of the labelled aviation notices to determine relevance of the labelled aviation notices to specific flight operations, aircraft types, or geographical areas. The prioritization process may consider factors, such as the urgency of the information, impact of the information on flight safety, and applicability of the information to current or planned operations. For example, labelled aviation notices affecting the immediate flight path or destination of an aircraft may be given higher priority than those pertaining to distant or irrelevant areas.

Although examples for the present disclosure have been described in language specific to structural features and/or methods, it is to be understood that the appended claims are not necessarily limited to the specific features or methods described. Rather, the specific features and methods are disclosed and explained as examples of the present disclosure.

1. A system comprising:
a processor; and
a machine-readable storage medium comprising instructions executable by the processor to:
obtain a plurality of tokens associated with an aviation notice, the aviation notice having a pre-defined format;
identify, using a machine learning model, one or more segments in the plurality of tokens, wherein a segment is indicative of an attribute associated with the aviation notice, and wherein the machine learning model is pre-trained on a set of attributes pertaining to flight related parameters pertaining to corresponding aviation notices;
based on pre-defined rules, associate a label with the attribute defined within each of the one or more segments, to obtain labelled aviation notice; and
transmit the labelled aviation notice to an avionic system.

2. The system as claimed in claim 1, wherein the aviation notice is a Notice to Airmen (NOTAM).

3. The system as claimed in claim 1, wherein the processor uses a natural language processing model trained to identify semantic relationships within the plurality of tokens.

4. The system as claimed in claim 1, wherein to obtain the plurality of tokens, the instructions are executable to cause the processor to extract a plurality of aviation notices based on pre-defined rules to obtain a valid set of aviation notices with the pre-defined format.

5. The system as claimed in claim 1, wherein the pre-defined rules are based on aviation industry standards, the pre-defined rules comprise a mapping between attributes and corresponding labels.

6. The system as claimed in claim 1, wherein the instructions are executable to cause the processor to:
determine an update pertaining to the aviation notice;
perform real-time modification to the labelled aviation notice based on the update; and
transmit the modified labelled aviation notice to the avionic system.

7. The system as claimed in claim 1, wherein the instructions executable by the processor are to re-train the machine learning model based on feedback received from a user regarding an accuracy of the labelled aviation notice.

8. The system as claimed in claim 1, wherein to identify the segments, the instructions executable by the processor are to generate vector embeddings for each token in the plurality of tokens.

9. A method comprising:
receiving an aviation notice from a first terminal, wherein the aviation notice has a pre-defined format;
generating a plurality of vector embeddings corresponding to the aviation notice, wherein each of the plurality of vector embeddings is indicative of a word in the aviation notice;
based on the plurality of vector embeddings, determining segment boundaries in the aviation notice, wherein a segment boundary separates a first attribute from a second attribute in the aviation notice;
associating a label, using a machine learning model, with each attribute defined in the aviation notice and determined by the segment boundary, wherein the machine learning model is pre-trained on a set of segments pertaining to attributes associated with corresponding aviation notices; and
displaying a labelled aviation notice on a second terminal.

10. The method as claimed in claim 9, wherein generating the vector embeddings comprises pre-processing the aviation notice to create word-level tokens.

11. The method as claimed in claim 9, wherein generating the plurality of vector embeddings comprises using a natural language processing model, wherein the natural language processing model is pre-trained on a plurality of word-level tokens associated with different types of aviation notices.

12. The method as claimed in claim 11, wherein the natural language processing model is a Bidirectional Encoder Representations from Transformers (BERT) model.

13. The method as claimed in claim 9, wherein determining the segment boundaries comprises applying a recurrent neural network (RNN) model to the plurality of vector embeddings, wherein the RNN model is pre-trained using a plurality of annotations of aviation notices such that each annotation is indicative of a segment of the aviation notice.

14. The method as claimed in claim 9, wherein the machine learning model is a conditional random forest (CRF) model.

15. The method as claimed in claim 9, wherein the method comprises validating the labelled aviation notice against a set of pre-defined rules specific to the pre-defined format of the aviation notice.

16. The method as claimed in claim 9, wherein the method comprises generating alerts based on specific attributes or combinations of attributes in the labelled aviation notice.

17. A non-transitory computer-readable medium comprising instructions, the instructions being executable by a processing resource of a system, to:
filtering a plurality of aviation notices based on pre-defined rules, to obtain a valid set of aviation notices, wherein the valid set of aviation notices has a pre-defined format;
generate a plurality of vector embeddings corresponding to each valid aviation notice from the set of valid aviation notices, wherein each of the plurality of vector embeddings is indicative of a word in the valid aviation notice;
input the plurality of vector embeddings in a machine learning model to detect one or more attributes associated with the aviation notices, wherein the machine learning model is pre-trained on a set of attributes pertaining to flight related parameters pertaining to corresponding aviation notices;
assign, by a sequence labelling model, one or more labels to each of the one or more attributes to generate a labelled aviation notice; and
notify the labelled aviation notice to an avionic system.

18. The non-transitory computer-readable medium as claimed in claim 17, wherein the machine learning model is a Bidirectional Long Short-Term Memory (BiLSTM) model.

19. The non-transitory computer-readable medium as claimed in claim 17, wherein the sequence labelling model is a Conditional Random Field (CRF) model, and wherein the instructions, when executed by the processing resource, cause the processing resource to re-train the CRF model based on feedback received regarding the accuracy of the labelled aviation notice.

20. The non-transitory computer-readable medium as claimed in claim 17, wherein the instructions, when executed by the processing resource, cause the processing resource to prioritize the labelled aviation notices based on relevance of the labelled aviation notices to a specific operation.
